(19) United States
(12) Patent Application Publication
(10) Pub. No.: US 2012/0102390 A1
(43) Pub. Date: Apr. 26, 2012

(54) METHOD AND APPARATUS FOR GENERATING WIDGET

(75) Inventors: Jie Zhang, Beijing (CN); Haifang Fu, Beijing (CN); Guang Ji, Beijing (CN); Guiling Wang, Beijing (CN)

(73) Assignee: Huawei Technologies Co., Ltd., Shenzhen (CN)

(21) Appl. No.: 13/339,135

(22) Filed: Dec. 28, 2011

Related U.S. Application Data
(63) Continuation of application No. PCT/CN2010/076466, filed on Aug. 30, 2010.

(30) Foreign Application Priority Data
Dec. 10, 2009 (CN) 200910258109.4

(51) Int. Cl. G06F 17/00

(52) U.S. Cl. 715/234

(57) ABSTRACT

A method and an apparatus for generating a widget are provided. This technical solution belongs to the field of network application technology. The method includes the following steps: the attribute information of the data to be obtained is created according to the web page specified by a user and the page fragment marked by the user on the web page (101); the structured data is obtained according to the created attribute information of the data to be obtained (102); the obtained structured data is converted to visual content (103). The apparatus includes a creation module, an obtaining module, and a converting module. By creating the attribute information of the data to be obtained and obtaining the structured data according to the created attribute information, this technical solution has the effect of meeting diverse user demands as far as possible.

### CROSS-REFERENCE TO RELATED APPLICATION

This application is a continuation of International Application No. PCT/CN2010/076466, filed on Aug. 30, 2010, which claims priority to Chinese Patent Application No. 200910258109.4, filed on Dec. 10, 2009, both of which are hereby incorporated by reference in their entireties.

### FIELD OF THE INVENTION

The present invention relates to the field of network application technology, and particularly, to a method and an apparatus for generating a widget.

### BACKGROUND OF THE INVENTION

The widget is a small utility program that runs in a computer or cell phone. It usually provides functions such as weather, news and memo to the user in conjunction with the network. With the popularization of the network, the application of widget is becoming wider and wider, the categories of widget are continuously increased, and the market is promising.

Currently there are two manners for generating a widget: program design and web page extraction. The program design means downloading, during the widget development, the provided Software Development Kit (SDK) and then to perform a software development similar to the traditional way, and the developers shall have certain programming experiences. The web page extraction means providing online tools to the user, thereby enabling the user himself to specify the interested content in the web page, and taking it as a template to generate the widget.

During the implementation of the present invention, the inventor found that the current two manners for generating a widget at least have the following defects.

The development threshold for the program design is high, and a user having no programming experience cannot participate therein, and the development cost is relatively high. In addition, since the developers are limited to those having programming experiences, the types of the developed widgets are also limited. For the widget generated by the web page extraction, if the web page in which the user specifies the interested content is called as the original web page, the content of the generated widget only depends on the content of the original web page. As the content of the original web page is limited, thus the functions of the widget generated by the web page extraction are also limited.

### SUMMARY OF THE INVENTION

In order to simplify the widget generating process to meet diverse user demands so far as possible, the embodiments of the present invention provide a method and an apparatus for generating a widget. The technical solutions are given as follows.

According to one aspect, a method for generating a widget, including:

Creating, according to a web page specified by a user and a page fragment marked by the user on the web page, attribute information of data to be obtained;

obtaining structured data according to the created attribute information of the data to be obtained; and

converting the obtained structured data to a visual content.

According to another aspect, an apparatus for generating a widget, including:

a creation module configured to create, according to a web page specified by a user and a page fragment marked by the user on the web page, attribute information of data to be obtained;

an acquisition module configured to obtain structured data according to the attribute information of the data to be obtained created by the creation module; and

a conversion module configured to convert the obtained structured data into a visual content.

By creating the attribute information of the data to be obtained and obtaining the structured data according to the created attribute information, the technical solutions according to the embodiments of the present invention make the obtained data be rich in content. In addition, since the attribute information of the data to be obtained is created according to the web page specified by the user, it is possible for the user to participate in the widget generation process directly, and the diverse user demands may be met as far as possible.

### BRIEF DESCRIPTION OF THE DRAWINGS

In order to more clearly describe the technical solutions of the embodiments of the present invention, the drawings to be used in the descriptions of the embodiments are briefly introduced as follows. Obviously, the following drawings just illustrate some embodiments of the present invention, and a person skilled in the art can obtain other drawings from these drawings without any creative effort.

FIG. 1 is a flowchart of a method for generating a widget according to Embodiment 1 of the present invention;

FIG. 2 is a flowchart of a method for generating a widget according to Embodiment 2 of the present invention;

FIG. 3 is a structure schematic diagram of a first apparatus for generating a widget according to Embodiment 3 of the present invention;

FIG. 4 is a structure schematic diagram of a creation module according to Embodiment 3 of the present invention;

FIG. 5 is a structure schematic diagram of another creation module according to Embodiment 3 of the present invention;

FIG. 6 is a structure schematic diagram of still another creation module according to Embodiment 3 of the present invention;

FIG. 7 is a structure schematic diagram of an acquisition module according to Embodiment 3 of the present invention;

FIG. 8 is a structure schematic diagram of a second apparatus for generating a widget according to Embodiment 3 of the present invention;

FIG. 9 is a structure schematic diagram of a third apparatus for generating a widget according to Embodiment 3 of the present invention; and

FIG. 10 is a structure schematic diagram of a fourth apparatus for generating a widget according to Embodiment 3 of the present invention.

### DETAILED DESCRIPTION OF THE PREFERRED EMBODIMENTS

In order to make the object, technical solutions and advantages of the present invention be clearer, the embodiments of the present invention will be detailedly described as follows with reference to the drawings.

### Embodiment 1

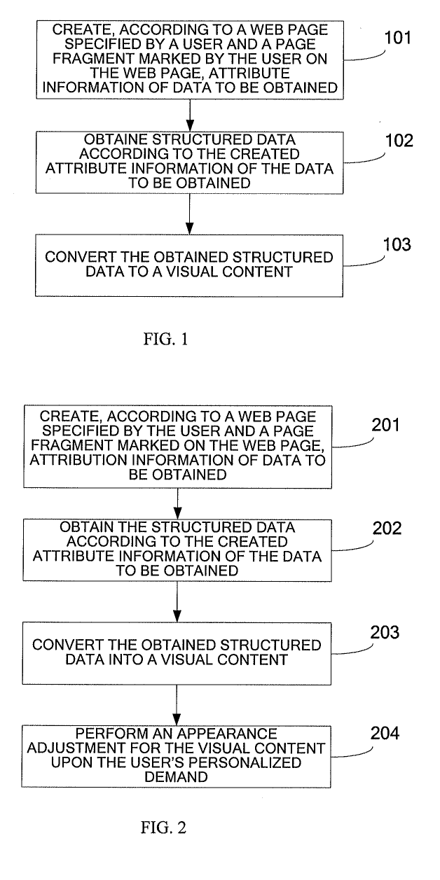

Referring to FIG. 1, this embodiment provides a method for generating a widget, including:

101: creating, according to a web page specified by a user and a page fragment marked by the user on the web page, attribute information of data to be obtained;

102: obtaining structured data according to the created attribute information of the data to be obtained; and

103: converting the obtained structured data to a visual content.

In summary, by creating the attribute information of the data to be obtained and obtaining the structured data according to the created attribute information, the method according to this embodiment makes the obtained data be rich in content. In addition, since the attribute information of the data to be obtained is created according to the web page specified by the user, it is possible for the user to participate in the widget generation process directly, and the diverse user demands may be met as far as possible.

### Embodiment 2

This embodiment provides a method for generating a widget. The method generates the widget by detecting the user's action of marking a page fragment of the web page, and obtaining the reusable structured data according to the page fragment marked by the user. Referring to FIG. 2, the method according to this embodiment includes:

201: creating, according to a web page specified by the user and a page fragment marked by the user on the web page, attribution information of data to be obtained;

With respect to this step, in order to generate the widget meeting the user's demand, the method according to this embodiment adopts a manner that the user may directly participate in. That is, the user specifies a web page, and after the web page specified by the user is loaded, the user creates, based on his interest and operation level and in the manners of different difficulties, simple or complex attribution information of the data to be obtained. The attribution information of the data to be obtained can be determined by detecting the user's action of marking a page fragment of the web page. After being marked by the user, the page fragment may be highlighted to the user. The action of marking may be realized through a simple operation of the user, such as clicking or selecting the page fragment. These operations are basic technologies in the website development, and herein are omitted. In addition, this embodiment does not limit the manner for the user to mark the page fragment.

In case the user selects to create the simple attribution information of the data to be obtained, after the web page specified by the user is loaded and it is detected that the user marks the page fragment of the web page, it is enough to obtain only path information corresponding to the page fragment marked by the user. The created attribution information of the data to be obtained at least includes the uniform resource locator and the path information. Of course, upon the user's demand, the created attribution information of the data to be obtained may further include other information such as data size, and the concrete content of the attribution information is not limited herein. The uniform resource locator corresponds to the web page specified by the user, and the path information corresponds to the page fragment marked by the user. That is, the simple attribution information only includes the attribution information of the page fragment marked by the user. When the user marks the interested page fragment on the specified web page, only path information corresponding to the marked page fragment is obtained. The path information is that of the page fragment marked by the user on the web page. In the actual application, there are many ways to represent the path information, and herein are not limited. For example, when XPath is adopted, the path information may be represented as /HTML [1]/BODY [1]/DIV [5]/DIV [3]/DIV [1]/OL [1]/LI/H3 [1]/A [1].

In case the user selects to create the complex attribution information of the data to be obtained, after the web page specified by the user is loaded and the user marks the page fragment of the web page, the page fragment similar to the page fragment marked by the user shall be identified, and pieces of path information corresponding to the page fragment marked by the user and the similar page fragment shall be obtained, respectively. Although the created complex attribution information of the data to be obtained also at least includes the uniform resource locators and pieces of path information, the uniform resource locators correspond to the web pages where the page fragment marked by the user and the similar page fragment are located respectively, and the pieces of path information correspond to the page fragment marked by the user and the similar page fragment respectively. That is, the complex attribution information includes not only the attribution information of the page fragment marked by the user but also the attribution information of the page fragment similar to the page fragment marked by the user. Assuming the user specified web page is a web page for search result, if the user marks two first search result entries, search result entries similar to the two will be identified. Next, path information corresponding to the two search result entries marked by the user and the search result entries similar thereto shall all be obtained.

The web page loading is a basic technology in the website development, and herein is omitted, and this embodiment does not limit the way of web page loading. The algorithm of identifying the similar page fragment has been introduced in many public academic literatures, and herein is omitted. The concrete algorithm of identifying the similar page fragment is not limited in this embodiment.

Preferably, in order to ensure the accuracy of the identified similar page fragment, after the similar page fragment has been identified, this embodiment detects the page fragment similar to that marked by the user, and adds or deletes the page fragment similar to that marked by the user according to the detection result. For example, in case the identified similar page fragment is detected as wrong, it may be deleted.

With respect to the creation of the complex attribution information of the data to be obtained, in order to improve the accuracy of identifying the similar page fragment, the user shall induce in the practice how to mark the representative page fragment. Although it is a high requirement for the user to mark the representative page fragment, the attribution information containing multiple page fragments can be provided, and the demand for more extensive data may be met.

After the similar page fragment is correctly identified and the path information respectively corresponding to the page fragment marked by the user and the page fragment similar thereto is obtained, the creation of the attribution information of the data to be obtained is completed. Attribution information of a plurality of data to be obtained can be created by repeating the creation process.

202: obtaining the structured data according to the created attribute information of the data to be obtained;

Specifically, first of all, corresponding new web page shall be downloaded according to the uniform resource locator in the attribution information of the data to be obtained.

The web page downloaded according to the uniform resource locator in the attribution information of the data to be obtained is called as a “new web page”, because most web pages are continuously updated, and even the contents of the web pages downloaded according to the same uniform resource locator in different time are also different from each other. With respect to this condition, in this embodiment the web page downloaded according to the uniform resource locator in the attribution information of the data to be obtained is generally called as the “new web page”.

Since some uniform resource locators contain the request parameter while some do not contain the request parameter, for different uniform resource locators, the step uses different manners to download corresponding new web page according to the uniform resource locator in the attribution information of the data to be obtained.

In case of a uniform resource locator does not contain a request parameter, such as http://www.aaaaa.com, the web page corresponding to the uniform resource locator can be downloaded directly when a corresponding new web page is download according to the uniform resource locator;

In case of a uniform resource locator contains a request parameter, such as http://www.aaaaa.com/search?h1=en&q=hd&aq=f in which h1, q and aq after “?” are all request parameters, the request parameters are used as variable parameters for the user to select and modify. If the user selects to modify the value hd of the request parameter q into hc, when a corresponding new web page is download according to the uniform resource locator, a new page corresponding to the uniform resource locator whose parameter has modified by the user shall be downloaded, i.e., a web page corresponding to the uniform resource locator http://www.aaaaa.com/search?h1=en&q=hc&aq=f shall be downloaded.

Secondly, after the corresponding new web page is downloaded according to the uniform resource locator in the attribution information of the data to be obtained, a new page fragment shall be extracted from the corresponding new web page according to the path information in the attribution information of the data to be obtained.

For the convenience of description, herein the web page specified by the user loaded during the creation of the attribution information of the data to be obtained is called as the original web page. Since the new web page is highly similar to the original web page, the new page fragment can be extracted from the corresponding new web page according to the path information in the attribution information of the data to be obtained. In case XPath is adopted and the path information is represented as /HTML [1]/BODY [1]/DIV [5]/DIV [3]/DIV [1]/OL [1]/LI/H3 [1]/A [1], the new page fragment can be extracted correctly with the same XPath, after the corresponding new web page is downloaded according to the uniform resource locator in the attribution information of the data to be obtained.

Finally, after the new page fragment is extracted, the extracted new page fragment is consolidated into the structured data.

During the actual application, the new web page fragments may be grouped based on their adjacent positional relationships in the web page, and consolidated into the structured data. For example, two pieces of attribution information of the data to be obtained are created, wherein the page fragment obtained according to one of the attribution information is the title of the search result, and the page fragment obtained according to another attribution information is the abstract of the search result. In this step, data groups of “the title of the search result+the abstract of the search result” can be compiled based on the adjacent positional relationship between the page fragments, and the two page fragments of each data group belong to the same search result. Thus a structured data table is formed by taking the search results as rows and taking the attributes as columns. Finally, the structured data is output. Herein the output format may be the internal data structure of a program, or a public format such as Extensible Markup Language (XML) or JavaScript Object Notation (JSON).

Optionally, when a plurality of structured data are obtained, the combination relationship between them shall be set in the following way: setting the attribution information of one structured data as the input parameter of another structured data, so that the plurality of structured data are combined and consolidated into one structured data. For example, two structured data are obtained as follows: one structured data has no running parameter, and the latest hot films and their box-office incomes are directly output by extracting the data in the professional film websites (the attribute names are set as “film name” and “box-office income”); and the other structured data takes the film name as a parameter (herein the parameter name depends on that of the marked page fragment on the original web page, and it is not certainly the “film name”), and the film projection cinema and time are extracted using the film search page (the attribute names are set as “projection cinema” and “projection time”). The “film name” attribute of the former structured data is set as the input parameter of the later structured data, i.e., the combination relationship between the two structured data is set by running the later structured data for each “film name”. Therefore, the two structured data can be run simultaneously to automatically obtain a hot film projection calendar containing four attributes “film name”, “box-office income”, “projection cinema” and “projection time”.

Optionally, the method according to this embodiment supports to process the obtained structured data upon the user's personalized demand, for example, providing a series of operators such as “ascending sort”, “descending sort”, “screening on condition”, etc. For example with respect to the above film projection calendar, the “descending sort” operator may be used for the “box-office income” to obtain the hot film projection ranking sorted in the box-office incomes; or the films projected in the user's free time may be selected by means of “screening on condition”, to facilitate the selection.

203: converting the obtained structured data into a visual content.

Specifically, since the method according to this embodiment is based on the network, the widget generated thereby can easily runs in a hand-held device (e.g., cell phone) that has a limited computation capability. The obtained structured data can be simply converted into the visual content by using the browser of a common computer or cell phone directly. For example, the structured data may be converted into a table structure of the Hyper Text Mark-up Language (HTML) and represented in the form of a table, or converted into a div structure to achieve different representation effects in cooperation with different Cascading Style Sheets (CSS). The HTML and the cooperated CSS not only can be downloaded through the browser in the computer or cell phone, but also can be encapsulated into an SDK to run in the computer or cell phone in the form of local application program. Till now, after the obtained structured data is converted into the visual content, the process of widget generation is completed. But in order to further meet the user's personalized demand, the following optional steps may be performed.

S204: performing an appearance adjustment for the visual content upon the user's personalized demand.

With respect to this step, in some embodiments, in order to meet the user's personalized demand and in consideration of the widget appearance, the method according to this embodiment can perform an appearance adjustment for the visual content upon the user's personalized demand. After the widget is converted into the visual content, the user interface is composed of elements such as HTML, CSS and JavaScript, thus the widget appearance may be adjusted by modifying these elements upon the user's demand, e.g., adjusting the style of the HTML elements and the display position of a certain data. For the combined structured data, the JavaScript may be used in cooperation to only display the user's interested data, so as to reduce the number of times of running the structured data. Finally, all settings made by the user are stored.

In summary, by creating the attribute information of the data to be obtained and obtaining the structured data according to the created attribute information, the method according to this embodiment makes the obtained data be rich in content. In addition, since the attribute information of the data to be obtained is created according to the web page specified by the user, it is possible for the user to participate in the widget generation process directly, and the diverse user demands may be met as far as possible. Further, the visual content may be adjusted upon the user's personalized demand to beautify the widget appearance, thereby further meeting the diverse user demands and improving the user's experience.

### Embodiment 3

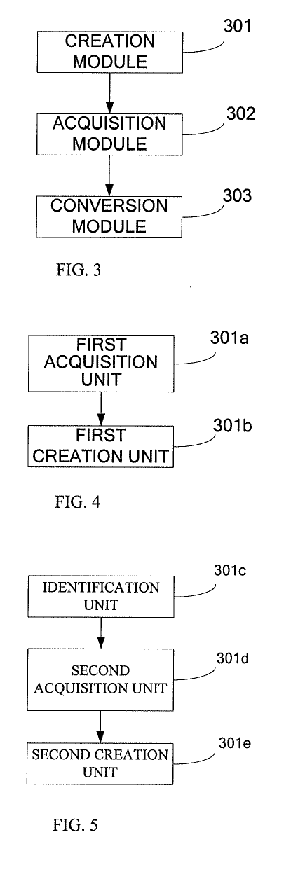

Referring to FIG. 3, this embodiment provides an apparatus for generating a widget, including:

a creation module 301 configured to create, according to a web page specified by a user and a page fragment marked by the user on the web page, attribute information of data to be obtained;

an acquisition module 302 configured to obtain structured data according to the attribute information of the data to be obtained created by the creation module 301; and

a conversion module 303 configured to convert the obtained structured data to a visual content.

Referring to FIG. 4, when the user creates simple attribute information of the data to be obtained, the creation module 301 includes:

a first acquisition unit 301a configured to load the web page specified by the user, and after detecting that the user marks the page fragment of the web page, obtain path information corresponding to the page fragment marked by the user; and

a first creation unit 301b configured to create the attribution information at least including uniform resource locator and path information for the data to be obtained, wherein the uniform resource locator is corresponding to the web page specified by the user, and the path information is corresponding to the page fragment marked by the user obtained by the first acquisition unit 301a.

Referring to FIG. 5, when the user creates complex attribute information of the data to be obtained, the creation module 301 includes:

an identification unit 301c configured to load the web page specified by the user, and after detecting that the user marks the page fragment of the web page, identifying a page fragment similar to the page fragment marked by the user;

a second acquisition unit 301d configured to obtain path information corresponding to the page fragment marked by the user and the similar page fragment respectively, wherein the similar page fragment is the page fragment identified by the identification unit 301c which is similar to the page fragment marked by the user; and

a second creation unit 301e configured to create the attribution information at least including uniform resource locator and path information for the data to be obtained, wherein the uniform resource locator corresponds to web pages where the page fragment marked by the user and the similar page fragment are located, respectively, and the path information corresponds to the page fragment marked by the user and the similar page fragment obtained by the second acquisition unit 301d respectively.

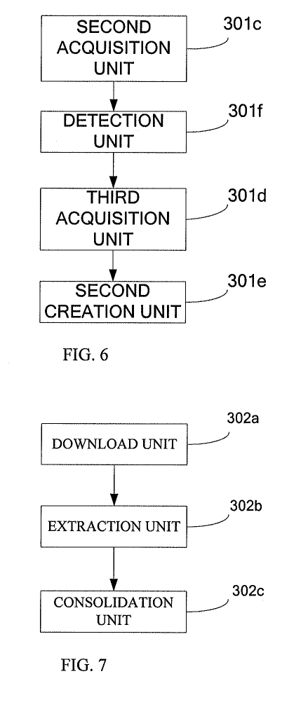

Preferably, referring to FIG. 6, when the user creates complex structured data, the creation module further includes:

a detection unit 301f configured to detect the page fragment similar to the page fragment marked by the user identified by the identification unit 301c, and add or delete the page fragment similar to the page fragment marked by the user according to the detection result.

Referring to FIG. 7, the acquisition module 302 includes:

a download unit 302a configured to download corresponding new web page according to the uniform resource locator in the attribution information of the data to be obtained;

an extraction unit 302b configured to extract a new page fragment from the corresponding new web page according to the path information in the attribution information of the data to be obtained; wherein the new web page is downloaded by the download unit 302a; and

a consolidation unit 302c configured to consolidate the page fragment extracted by the extraction unit 302b into structured data.

The download unit 302a is specifically configured to download the new web page corresponding to the uniform resource locator in case that the uniform resource locator does not contain a request parameter; or use the request parameters as variable parameters for the user to select and modify in case that the uniform resource locator contains the request parameter, and

download a new page corresponding to the uniform resource locator whose request parameter has been modified by the user.

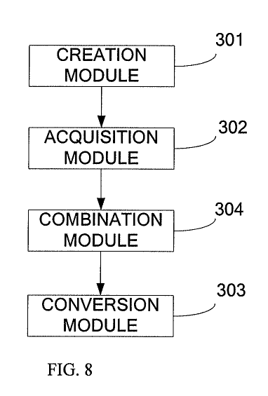

Preferably, referring to FIG. 8, the apparatus further includes:

a combination module 304 configured to set attribution information of one structured data as an input parameter of another structured data, so that a plurality of structured data are combined and consolidated into one structured data.

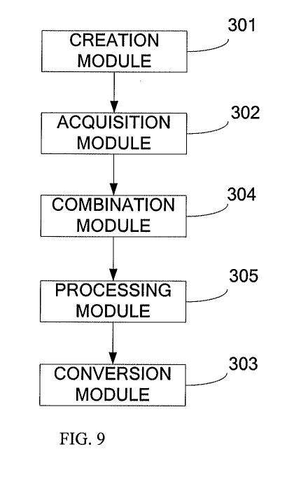

Preferably, referring to FIG. 9, the apparatus further includes:

a processing module 305 configured to process the structured data combined by the combination module 304, upon the user's demand.

The structured data to be processed by the processing module 305 may be the structured data obtained by the acquisition module 302. In this embodiment, the structured data to be processed by the processing module 305 is not limited. Herein, for example the structured data combined by the combination module 304 is taken as the structured data to be processed by the processing module 305.

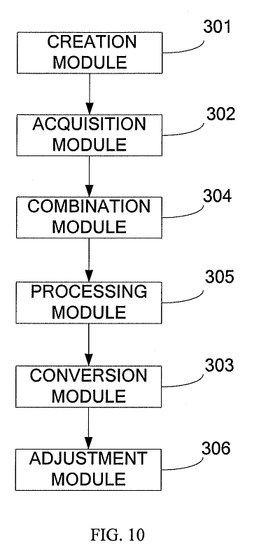

Further, referring to FIG. 10, the apparatus further includes:

an adjustment module 306 configured to perform an appearance adjustment for the visual content converted by the conversion module 303 upon the user's personalized demand.

In the actual application, the apparatus according to the embodiment of the present invention may execute the technical solution of the method Embodiment 1 or 2:

firstly, the creation module 301 creates the attribution information of the data to be obtained; the creation of simple attribution information of the data to be obtained is implemented by the first acquisition unit 301a and the first creation unit 301b in the creation module 301; and the creation of complex attribution information of the data to be obtained is implemented by the identification unit 301c, the second acquisition unit 301d and the second creation unit 301e in the creation module 301;

secondly, the structured data is obtained by the download unit 302a, the extraction unit 302b and the consolidation unit 302c in the acquisition module 302;

finally, the conversion module 303 converts the structured data obtained by the acquisition module 302 into the visual content, thereby generating a widget.

In summary, by creating the attribute information of the data to be obtained and obtaining the structured data according to the created attribute information, the apparatus according to this embodiment makes the obtained data be rich in content. In addition, since the attribute information of the data to be obtained is created according to the web page specified by the user, it is possible for the user to participate in the widget generation process directly, and the diverse user demands may be met as far as possible. Further, as appearance adjustment of the visual content is also supported by this apparatus according to this embodiment, the diverse user demands are met and the user's experience is improved.

The serial numbers of the above embodiments of the present invention are just made for the convenience of description, rather than indicating the merit ranking.

A person skilled in the art shall appreciate that all or a part of flows in the methods according to the above embodiments may be implemented by instructing relevant hardware through a program that may be stored in a computer readable storage medium, and when being executed, the program includes the flows of the method embodiments. The storage medium may be magnetic disk, optical disk, Read-Only Memory (ROM) or Random Access Memory (RAM), etc.

The above descriptions are just preferred embodiments of the present invention, rather than limitations thereto. Any modification, equivalent replacement, improvement, etc. made under the spirit and principle of the present invention shall fall within the protection scope of the present invention.

What is claimed is:

1. A method for generating a widget, comprising:
creating, according to a web page specified by a user and a page fragment marked by the user on the web page, attribute information of data to be obtained;
obtaining structured data according to the created attribute information of the data to be obtained; and
converting the obtained structured data to a visual content.

2. The method according to claim 1, wherein the creating, according to the web page specified by the user and the page fragment marked by the user on the web page, the attribute information of the data to be obtained comprises:
loading the web page specified by the user, and after detecting that the user marks the page fragment of the web page, obtaining path information corresponding to the page fragment marked by the user; and
creating the attribution information at least including uniform resource locator and path information for the data to be obtained, wherein the uniform resource locator corresponds to the web page specified by the user, and the path information corresponds to the page fragment marked by the user.

3. The method according to claim 1, wherein the creating, according to the web page specified by the user and the page fragment marked by the user on the web page, the attribute information of the data to be obtained comprises:
loading the web page specified by the user, and after detecting that the user marks the page fragment of the web page, identifying a page fragment similar to the page fragment marked by the user;
obtaining path information corresponding to the page fragment marked by the user and the similar page fragment respectively; and
creating the attribution information at least including uniform resource locators and pieces of path information for the data to be obtained, wherein the uniform resource locators correspond to web pages where the page fragment marked by the user and the similar page fragment are located respectively, and the pieces of path information correspond to the page fragment marked by the user and the similar page fragment respectively.

4. The method according to claim 1, wherein the obtaining the structured data according to the created attribute information of the data to be obtained comprises:
downloading corresponding new web page according to the uniform resource locator in the attribution information of the data to be obtained;
extracting a new page fragment from the corresponding new web page according to the path information in the attribution information of the data to be obtained; and
consolidating the extracted page fragment into structured data.

5. The method according to claim 4, wherein the downloading the corresponding new web page according to the uniform resource locator in the attribution information of the data to be obtained comprises:
downloading the new web page corresponding to the uniform resource locator in case that the uniform resource locator does not contain a request parameter; or
using, in case that the uniform resource locator contains request parameter, the request parameter as variable parameter for the user to select and modify, and downloading a new page corresponding to the uniform resource locator with the request parameter modified by the user.

6. An apparatus for generating a widget, comprising:
a creation module configured to create, according to a web page specified by a user and a page fragment marked by the user on the web page, attribute information of data to be obtained;
an acquisition module configured to obtain structured data according to the attribute information of the data to be obtained created by the creation module; and
a conversion module configured to convert the obtained structured data into a visual content.

7. The apparatus according to claim 6, wherein the creation module comprises:
a first acquisition unit configured to load the web page specified by the user, and after detecting that the user marks the page fragment of the web page, obtain path information corresponding to the page fragment marked by the user; and
a first creation unit configured to create the attribution information at least including uniform resource locator and path information for the data to be obtained, wherein the uniform resource locator corresponds to the web page specified by the user, and the path information corresponds to the page fragment marked by the user obtained by the first acquisition unit.

8. The apparatus according to claim 6, wherein the creation module comprises:
an identification unit configured to load the web page specified by the user, and after detecting that the user marks the page fragment of the web page, identifying a page fragment similar to the page fragment marked by the user;
a second acquisition unit configured to obtain path information corresponding to the page fragment marked by the user and the similar page fragment respectively, wherein the similar page fragment is the page fragment identified by the identification unit which is similar to the page fragment marked by the user; and
a second creation unit configured to create the attribution information at least including uniform resource locators and pieces of path information for the data to be obtained, wherein the uniform resource locators correspond to web pages where the page fragment marked by the user and the similar page fragment are located, respectively, and the pieces of path information correspond to the page fragment marked by the user and the similar page fragment obtained by the second acquisition unit, respectively.

9. The apparatus according to claim 6, wherein the acquisition module comprises:
a download unit configured to download corresponding new web page according to the uniform resource locator in the attribution information of the data to be obtained;
an extraction unit configured to extract a new page fragment from the corresponding new web page according to the path information in the attribution information of the data to be obtained; wherein the new web page is downloaded by the download unit; and
a consolidation unit configured to consolidate the page fragment extracted by the extraction unit into structured data.

10. The apparatus according to claim 9, wherein the download unit is specifically configured to download the new web page corresponding to the uniform resource locator in case that the uniform resource locator does not contain a request parameter; or use, in case that the uniform resource locator contains request parameter, the request parameters as variable parameters for the user to select and modify, and download a new page corresponding to the uniform resource locator with the request parameter modified by the user.
